(19) United States
(12) Patent Application Publication
(10) Pub. No.: US 2026/0054605 A1
(43) Pub. Date: Feb. 26, 2026

(54) PREDICTIVE ENERGY MANAGEMENT TECHNIQUES FOR FUEL CELL ELECTRIC VEHICLES

(71) Applicant: FCA US LLC, Auburn Hills, MI (US)

(72) Inventors: Barry A. Mason, Auburn Hills, MI (US); Jochen Schaffnit, Hessen (DE); Remy Fontaine, Hessen (DE); Andreas Roesch, Hessen (DE)

(21) Appl. No.: 18/812,275

(22) Filed: Aug. 22, 2024

(51) Int. Cl. B60L 58/30; B60L 58/13

(52) U.S. Cl. CPC B60L 58/30; B60L 58/13; B60L 2240/642; B60L 2240/662; B60L 2260/54

(57) ABSTRACT

A predictive energy management technique for a fuel cell electric vehicle (FCEV) includes determining a state of charge (SOC) profile for a battery system of an electrified powertrain that also includes an electric motor, the SOC profile defining a plurality of SOC allocations for a plurality of trip segments, applying a set of constraints of the FCEV to the SOC profile to obtain a target SOC profile, wherein the set of constraints include at least one or more constraints for operation of a fuel cell system of the electrified powertrain, determining a dynamic fuel cell power to achieve the target SOC profile at each of the plurality of trip segments, filtering the dynamic fuel cell power to obtain a predictive fuel cell power request for the fuel cell system, and controlling the fuel cell system using the predictive fuel cell power request.

### FIELD

The present application relates to fuel cell electric vehicles (FCEVs) and, more particularly, to predictive energy management techniques for determining the fuel cell power request of FCEVs.

### BACKGROUND

Range is discussed as one of the major issues in preventing certain consumers from considering/purchasing electrified vehicles (EVs). Some EVs, also known as range-extended electrified vehicles (REEVs), include secondary power sources (an internal combustion engine, a fuel cell system, etc.) that operates to recharge the vehicle's battery system and thereby increase the vehicle's range. One such type of REEV is a fuel cell electric vehicle (FCEV), which includes a fuel cell system that generates energy for recharging the vehicle's battery system in response to a fuel cell power request. This fuel cell power request is conventionally set instantaneously based on the battery system state of charge (SOC). This conventional control technique can result in the fuel cell system having to work beyond its peak efficiency, particularly during high load operation scenarios. Accordingly, while such conventional fuel cell power request control techniques do work for their intended purpose, there exists an opportunity for improvement in the relevant art.

### SUMMARY

According to one example aspect of the invention, a predictive energy management system for a fuel cell electric vehicle (FCEV) is presented. In one exemplary implementation, the predictive energy management system comprises a set of sensors configured to monitor a set of parameters relating to operation of an electrified powertrain of the FCEV during a trip, the trip including a plurality of trip segments and the electrified powertrain including a battery system having a state of charge (SOC), a fuel cell system, and an electric motor and a control system configured to determine, based on the set of parameters, an SOC profile defining a plurality of SOC allocations for the plurality of trip segments, apply a set of constraints of the FCEV to the SOC profile to obtain a target SOC profile, wherein the set of constraints include at least one or more constraints for operation of a fuel cell system of the electrified powertrain, determine a dynamic fuel cell power to achieve the target SOC profile at each of the plurality of trip segments, filter the dynamic fuel cell power to obtain a predictive fuel cell power request for the fuel cell system, and control the fuel cell system using the predictive fuel cell power request.

In some implementations, the filtering of the dynamic fuel cell power includes applying a forward-looking average (FLA) filter to the dynamic fuel cell power. In some implementations, the predictive fuel cell power request includes a plurality of unique FLA-filtered fuel cell power segments for the plurality of trip segments, respectively. In some implementations, the applying of the FLA filter to the dynamic fuel cell power includes calculating the unique FLA-filtered fuel cell power segments between a minimum SOC level for the battery system, a maximum SOC level for the battery system, a start of the trip, and an end of the trip.

In some implementations, the set of constraints includes at least a minimum power output of the fuel cell system and a maximum power output of the fuel cell system. In some implementations, the set of constraints further includes at least a minimum SOC level of the battery system and a maximum SOC level of the battery system. In some implementations, the set of operating parameters includes at least one of navigation information and environmental information. In some implementations, the set of operating parameters includes both navigation information and environmental information, wherein the navigation information includes a set of road parameters including at least a road grade and posted speed limit, and wherein the environmental information includes at least an ambient temperature and an altitude or barometric pressure. In some implementations, the controlling of the fuel cell system using the predictive fuel cell power request results in at least one trip segment where the battery system SOC increases.

According to another example aspect of the invention, a predictive energy management method for an FCEV is presented. In one exemplary implementation, the predictive energy management method comprises monitoring, by a set of sensors of the FCEV, a set of parameters relating to operation of an electrified powertrain of the FCEV during a trip, the trip including a plurality of trip segments and the electrified powertrain including a battery system having an SOC, a fuel cell system, and an electric motor, determining, by a control system of the FCEV and based on the set of parameters, an SOC profile defining a plurality of SOC allocations for the plurality of trip segments, applying, by the control system, a set of constraints of the FCEV to the SOC profile to obtain a target SOC profile, wherein the set of constraints include at least one or more constraints for operation of a fuel cell system of the electrified powertrain, determining, by the control system, a dynamic fuel cell power to achieve the target SOC profile at each of the plurality of trip segments, filtering, by the control system, the dynamic fuel cell power to obtain a predictive fuel cell power request for the fuel cell system, and controlling, by the control system, the fuel cell system using the predictive fuel cell power request.

In some implementations, the filtering of the dynamic fuel cell power includes applying, by the control system, an FLA filter to the dynamic fuel cell power. In some implementations, the predictive fuel cell power request includes a plurality of unique FLA-filtered fuel cell power segments for the plurality of trip segments, respectively. In some implementations, the applying of the FLA filter to the dynamic fuel cell power includes calculating, by the control system, the unique FLA-filtered fuel cell power segments between a minimum SOC level for the battery system, a maximum SOC level for the battery system, a start of the trip, and an end of the trip.

In some implementations, the set of constraints includes at least a minimum power output of the fuel cell system and a maximum power output of the fuel cell system. In some implementations, the set of constraints further includes at least a minimum SOC level of the battery system and a maximum SOC level of the battery system. In some implementations, the set of operating parameters includes at least one of navigation information and environmental information. In some implementations, the set of operating parameters includes both navigation information and environmental information, wherein the navigation information includes a set of road parameters including at least a road grade and posted speed limit, and wherein the environmental information includes at least an ambient temperature and an altitude or barometric pressure. In some implementations, the controlling of the fuel cell system using the predictive fuel cell power request results in at least one trip segment where the battery system SOC increases.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIGS. 1A-1B are plots illustrating charge depletion, charge sustaining (CDCS) and blended charge depletion (BCD) control techniques for range-extended electrified vehicles (REEVs) according to the prior art;

FIG. 1C is another plot illustrating a predictive energy management technique for a fuel cell electric vehicle (FCEV) according to the principles of the present application;

FIG. 1D is another plot illustrating existing and new energy management techniques for a non-plug-in charging capable vehicle according to the principles of the present application;

FIG. 2 is a functional block diagram illustrating an example FCEV having an example predictive energy management system according to the principles of the present application;

FIG. 3 is a functional block diagram illustrating an example architecture for the predictive energy management system of FIG. 2 according to the principles of the present application;

FIG. 4 is a flow diagram illustrating an example predictive energy management method including predictive fuel cell power requests for a FCEV according to the principles of the present application;

FIGS. 5A-5B are plots illustrating an example horizon energy based segmentation of a vehicle trip and a corresponding example SOC allocation process according to the principles of the present application; and

FIGS. 5C-5D are plots illustrating an example dynamic fuel cell power request and a corresponding example forward-looking averaged (FLA) fuel cell power request according to the principles of the present application.

### DESCRIPTION

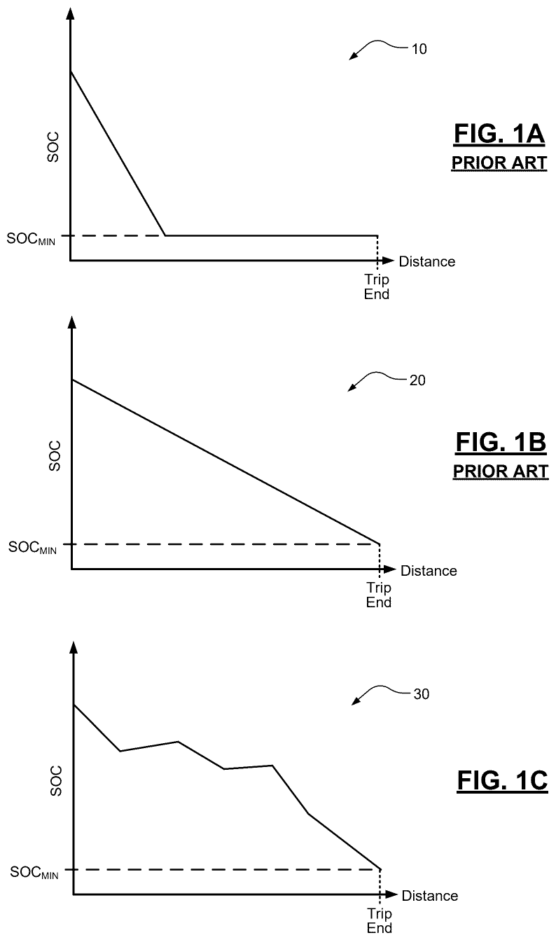

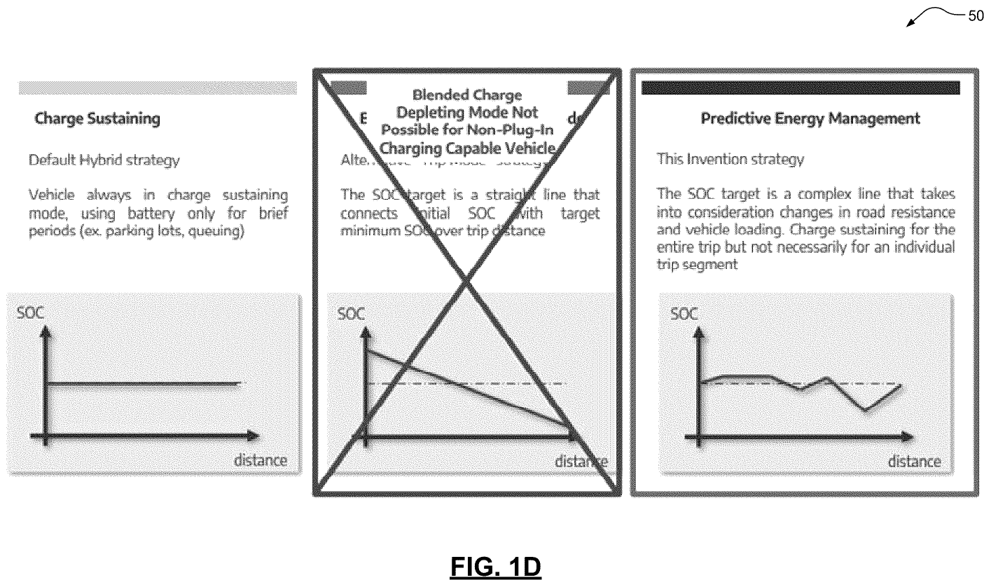

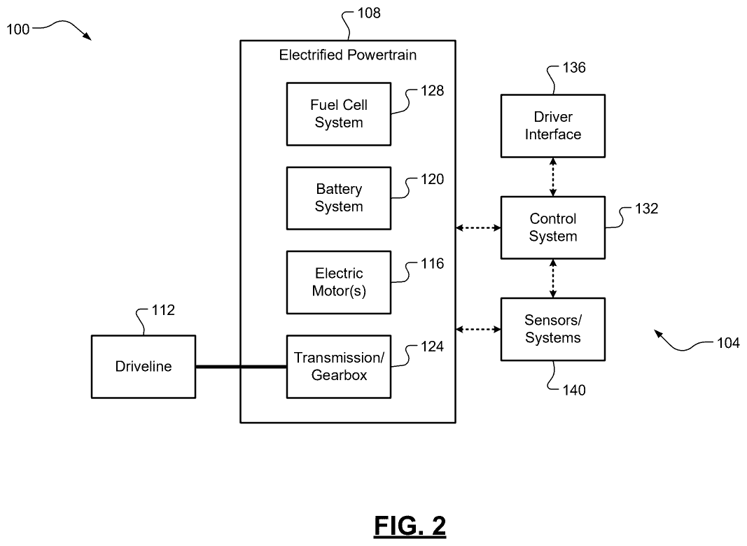

Conventional range-extended electrified vehicles (REEVs) typically operate in a “charge depletion, charge sustaining” (CDCS) mode where battery charge is depleted first to minimize instantaneous fuel consumption, followed by maintaining a target level of battery state of charge (SOC). The general operation of this CDCS control technique is shown in plot 10 of FIG. 1A. This CDCS control technique may be noticeable to the driver (i.e., a quickly depleting EV range value) and also requires shifting to a secondary power source (e.g., an engine) to supplement the battery SOC. For example, in an engine-based REEV, the engine could be audibly noticeable and tend to operate at a higher speed than a conventional vehicle giving the perception of reduced capability. A conventional charge sustaining (CS) technique, as shown in plot 50 of FIG. 1D, could also be applicable to non-plug-in charging capable vehicles as discussed in greater detail below.

Another recently-proposed control technique for REEVs is a “blended charge depletion” (BCD) mode. This BCD control technique accounts for a variety of factors in determining how battery charge is depleted in a blended fashion with the secondary power source during a vehicle trip. In other words, during the BCD mode, both (i) the engine or a fuel cell system and (ii) the battery are continuously utilized to deplete the battery SOC more slowly or gradually (compared to the CDCS mode) over a vehicle trip. For example, while operating in the BCD mode, the battery system SOC could be depleted to a target minimum SOC (shown by the dashed line) at a constant or linear rate across the entire trip as shown in plot 20 of FIG. 1B. As shown in plot 50 of FIG. 1D, this BCD technique is not applicable to non-plug-in charging capable vehicles (e.g., fuel cell electric vehicles, or FCEVs) and thus there exists an opportunity for improvement.

In FCEVs, a fuel cell system replaces the engine as the secondary power source. In a parallel-hybrid type FCEV, the fuel cell system can recharge the battery system or supply energy directly to the electric motor(s). Fuel cell systems are a newer technology that perform a chemical reaction to convert a fuel (e.g., hydrogen, or H2) into electrical energy (current). This process, however, cannot be “reversed” (i.e., current cannot be converted back into fuel/H2). Fuel cell systems have different operation strategies and constraints than engines and therefor require completely different control compared to engine-based hybrids or REEVs. Further, fuel cell systems may also be slow to respond to power requests depending the fuel cell system design, e.g. how quickly a compressor can provide oxygen from ambient air. Thus, these conventional CDCS and BCD modes, while useful for engine-based REEVs, are not particularly useful for FCEVs.

Accordingly, new predictive energy management techniques for FCEVs are presented herein. These predictive energy management techniques utilize a predictive fuel cell power request for predictive control of the fuel cell system during a vehicle trip (see plot 30 of FIG. 1C and plot 50 of FIG. 1D). This process includes (1) determining an SOC profile for the trip, (2) enforcing fuel cell system constraints against the SOC profile, (3) determining a dynamic fuel cell power for the constrained (target) SOC profile, and finally (4) filtering (e.g., forward-looking averaging, or FLA filtering) the dynamic fuel cell power to determine the final fuel cell power requests. As shown in plot 30 of FIG. 1C, the battery system SOC may increase during at least some of the trip segments (although this will not necessarily occur). Potential benefits of these techniques include more efficient FCEV operation and an improved customer experience.

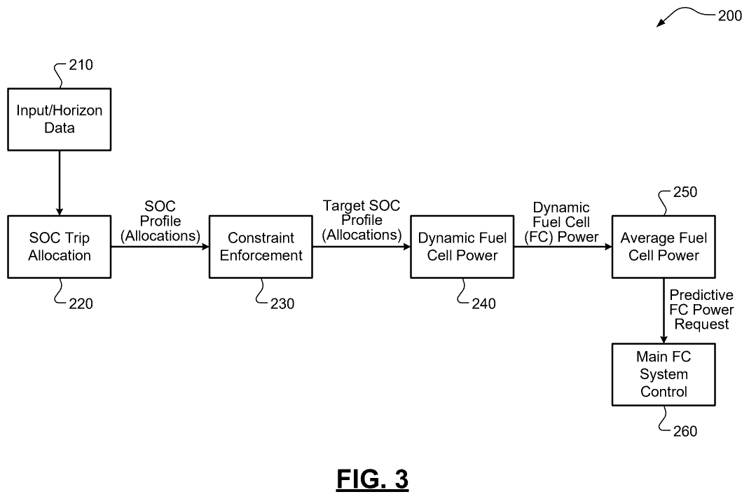

Referring now to FIG. 2, a functional block diagram of an example FCEV 100 (also “vehicle 100”) having an example predictive energy management system 104 according to the principles of the present application is illustrated. It will be appreciated that this is merely one example configuration for the FCEV 100 and that the predictive energy management techniques of the present application could be applicable to any suitable configured FCEV. As shown, the FCEV 100 comprises an electrified powertrain 108 configured to generate and transfer drive torque to a driveline 112 for vehicle propulsion. The electrified powertrain 108 comprises one or more electric motors 116 (e.g., three-phase AC electric traction motors) powered by a high voltage battery pack or system 120 and/or a fuel cell system 128 and configured consume electrical energy to provide the drive torque and generate electrical energy to recharge the battery system 120. The drive torque from electric motor(s) 116 is transferred to the driveline 112 via a transmission or gearbox 124 (a single-speed gear reducer, a multi-speed automatic transmission, a continuously-variable transmission, or CVT, etc.).

The electrified powertrain 108 also includes the above-mentioned fuel cell system 128 (e.g., an H2 fuel cell system or other suitable fuel cell system). The fuel cell system 128 includes a fuel tank, a fuel cell stack, and other necessary components (valves, regulators, etc.) for converting a fuel (e.g., H2) to electrical energy. The electrical energy generated by the fuel cell system 128 is used to (i) recharge the battery system 120 and/or to (ii) power the electric motor(s) 116. It will be appreciated that the electrified powertrain 108 could further include a DC-DC converter (not shown) for stepping up/down voltages of the various components described herein. It will also be appreciated that the electrified powertrain 108 could also include an internal combustion engine similar to other conventional REEVs in place of the fuel cell system 128.

A controller or control system 132 controls operation of the FCEV 100, including primarily controlling the electrified powertrain 108 to generate a desired amount of drive torque to satisfy a driver torque request received from a driver via a driver interface 136 (e.g., an accelerator pedal). The control system 132 may include a plurality of controllers (e.g., an electrified vehicle control unit, or EVCU, a motor control processor, or MCP control unit, and a fuel cell propulsion system, or FCPS control unit). The control system 132 receives inputs from a plurality of sensors and/or other vehicle systems 140 (also, “sensors 140”). Non-limiting examples of the set of parameters measurable by the sensors 140 include positions/speeds/accelerations, pressures, temperatures, and electrical parameters (voltage, current, etc.). Some parameters, such as the SOC of the battery system 120, could also be estimated based on other measured parameters. The control system 132 is also configured to perform at least a portion of the predictive energy management techniques of the present application.

As mentioned, the sensors 140 can also include other vehicle systems, such as a navigation/maps system (e.g., including a global navigation satellite system, or GNSS transceiver), a vehicle weight or trailer payload sensor, and a vehicle mode sensor (normal, long trip, tow/haul, tow/haul+electric, etc.), which could be part of the driver interface 136. Inputs provided by the navigation/maps system include, for example only, at least a destination for the trip, a route of travel to the trip destination, and road characteristics along the travel route. The road characteristics along the travel route include, for example only, at least some of road type (e.g., EV-only, or LEZ zones), road surface type (major paved road, rural paved road, unpaved road, etc.), road grade (include/decline), road speed limits, and traffic conditions. The sensors 140 could also monitor environmental data, such as ambient temperature, altitude or barometric pressure, and weather conditions.

Referring now to FIG. 3, a functional block diagram illustrating an example system architecture 200 for the predictive energy management system 104 according to the principles of the present application is illustrated. It will be appreciated that this system architecture 200 is merely one example configuration of the predictive energy management system 104 and that other suitable configurations could be utilized. As mentioned above, the predictive energy management system 104 generally includes the control system 132 and the sensors 140. It will be appreciated that certain aspects or operations of the predictive energy management techniques could be distributed processes amongst multiple control units of the control system 132 or could be integrated into one single control unit of the control system 132.

Initially, input data 210 is obtained. This input data 210 could include any of the relevant data previously described with respect to the sensors 140. For example only, road grade/slope, road speed limit, traffic signs, traffic patterns, ambient temperature, and altitude could be gathered to form the input data 210. This input data 210 could also be referred to as “horizon data” as it relates to a future horizon of the operating conditions of the FCEV 100 during the trip. In one exemplary implementation, the minimum amount of horizon data could include (i) a posted speed limit versus distance, (ii) a road grade versus distance, (iii) distance (e.g., a vector from a current position), and (iv) a total trip length. In one exemplary implementation, an expanded amount of horizon data includes the minimum horizon data plus (i) road artifacts (stop signs, yield signs, etc.) versus distance, (ii) altitude versus distance, (iii) ambient temperature versus distance, (iv) relative wind speed versus distance, and (v) traffic patterns (congestion, construction, etc.) versus distance.

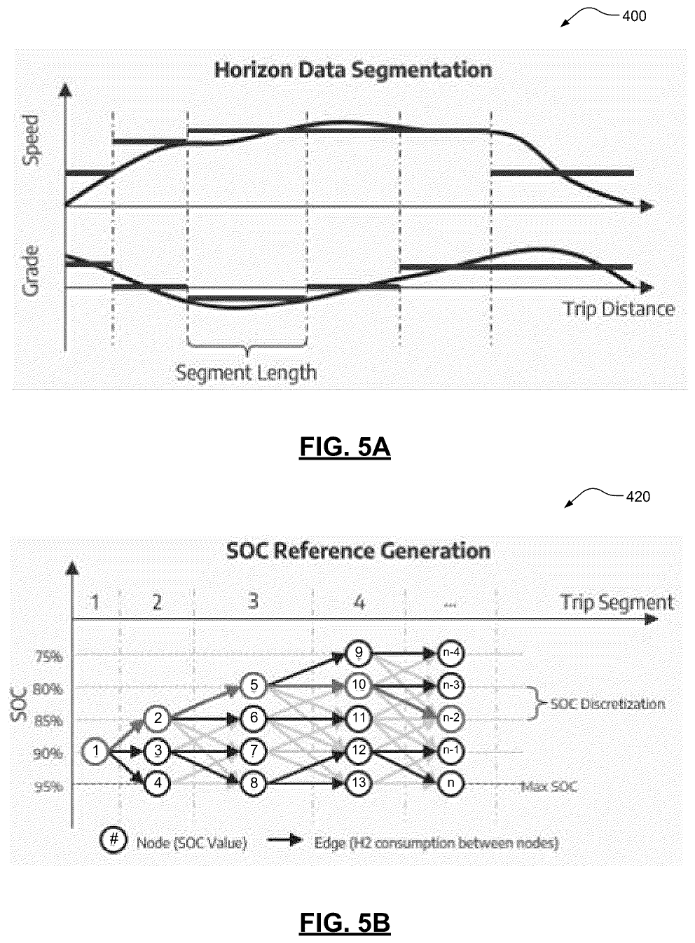

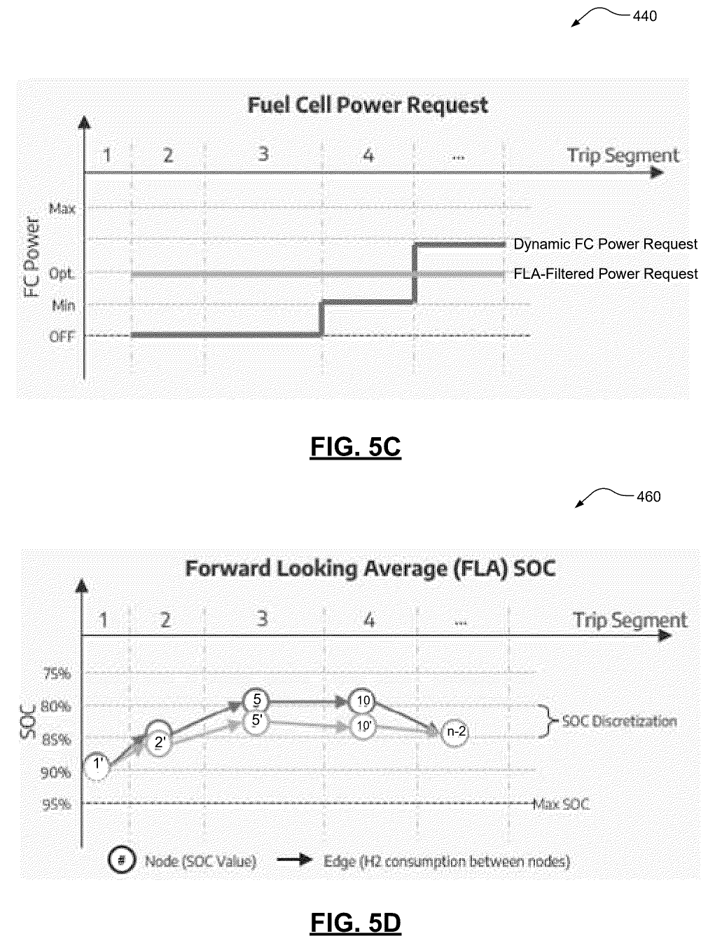

The input (horizon) data is provided to an SOC trip allocation 220. This SOC trip allocation determines an SOC profile based on the input data 210. This SOC profile defines an SOC allocation for each segment of the current trip of the FCEV 100. For example, the current trip of the FCEV 100 could have been previously defined or input (e.g., by the driver via the driver interface 136) based on a final endpoint or destination. The entire trip is then divided into a plurality of trip segments, each of which is expected to have a relatively static set of characteristics (road grade, speed limit, traffic, etc.). In one exemplary implementation, the input (horizon) data 210 is grouped into segments having equal energy and not equal distance or time. For example, three different energy segments could be (i) a road load-based energy at certain vehicle speed, (ii) an acceleration energy, and (iii) a potential energy due to road grade. An example horizon energy based segmentation is illustrated in plot 400 of FIG. 5A.

Based on the starting SOC of the battery system 120 and a minimum SOC level for the battery system 120, SOC allocation across the plurality of trip segments is performed to obtain this SOC profile for the trip. This SOC allocation 220 can also be re-run throughout the trip if the actual SOC of the battery system 120 differs from the target SOC profile by more than a calibratable threshold amount. The size of each trip segment could be calibratable using a defined SOC discretization (e.g., 5% intervals). A maximum discharge for each segment could correspond to an EV (non-FC mode) and could be the same as the SOC discretization (e.g., 5%) and the maximum charging for each segment could depend on the segment time or duration and the maximum output power of the fuel cell system 128 (e.g., 40 kW), thereafter converted to an SOC percentage. In one exemplary implementation, a grid of a plurality of possible SOC nodes is generated for the trip and an example is illustrated in the plot 420 of FIG. 5B. Each node connection (edge) has a cost (H2 consumption) and the lowest cost to get to each node is stored. The optimal solution could be determined via a dynamic programming approach as a path that minimizes the cost between the starting SOC and a target/final SOC value.

At 230, constraints are applied to or enforced against the SOC profile (i.e., the plurality of SOC allocations). These constraints are based on operational limitations of the FCEV 100 and its components. The fuel cell system 128, in particular, has some operational limitations for durability reasons (a warm-up period, limits on the frequency of on/off transitions, etc.). These could include, for example, minimum and maximum output powers of the FCEV 100. The battery system 120 could also have operational limitations, such as minimum and maximum SOC levels that the battery system 120 should be kept between in order to maximize its useful life and also ensure at least some operability of the FCEV 100 when the minimum SOC level is actually reached (e.g., a maximum SOC level of ˜95% and a minimum SOC level of ˜20%). If these constraints are not met or able to be enforced, the SOC allocation 220 could then be re-run (e.g., on the partial trip remaining).

At 240, a dynamic fuel cell power required to achieve the (constrained) target SOC profile (i.e., the plurality of target SOC allocations). This dynamic fuel cell power request represents a variable fuel cell power that the fuel cell system 128 would need to generate/output in order to achieve the target SOC profile at every stage (e.g., every trip segment) of the entire trip. An example dynamic fuel cell power request corresponding to the optimal solution shown in FIG. 5B and discussed above is also shown in plot 440 of FIG. 5C. At 250, a filtering of this dynamic fuel cell power is calculated. This filtering of the dynamic fuel cell power could be performed, for example, to smooth the power commands being provided to the fuel cell system 128. In one exemplary implementation, the filtering includes applying a forward-looking average (FLA) filtering approach or algorithm to more accurately controls this averaging/smoothing of the fuel cell system power control (see plot 440 of FIG. 5C). For illustrative purposes, an alternate view of the optimal SOC allocation solution (see FIGS. 5B and 5C) and the SOC resulting from the FLA fuel cell power request is also shown in plot 460 of FIG. 5D.

After applying this filtering (e.g., FLA filtering), a predictive fuel cell power request is obtained, which is then provided to a main fuel system control 260 that then controls the fuel cell system 128 accordingly. Some of the benefits of the FLA filtering approach include (i) improved fuel cell durability due to reduced transient power requests, (ii) optimum SOC trajectory generally followed with the starting SOC, target/ending SOC, and the minimum/maximum SOC levels still achieved at the same point in the trip, (iii) reduced fuel (H2) consumption, and (iv) future kinetic energy recovery (e.g., regenerative braking) could be anticipated to maximize the energy recovered into the battery system 120 and also minimizing conventional friction brake usage (e.g., down extended downhill grades) thereby extending their lifetime. This FLA filtering approach, however, should account for (i) special use cases for when the FLA segment power is below the minimum fuel cell system power and (ii) special use cases for an extended time at the minimum or maximum SOC level.

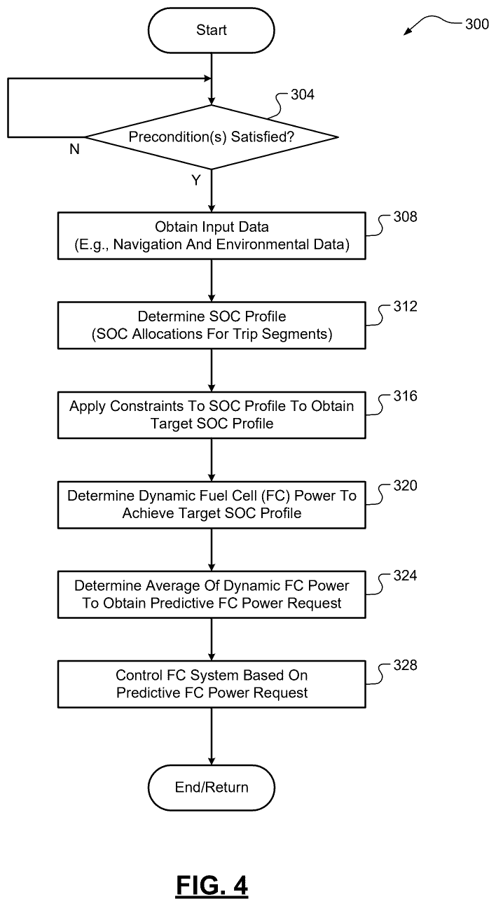

Referring now to FIG. 4, a flow diagram of an example predictive energy management method 300 for an FCEV according to the principles of the present application is illustrated. While the FCEV 100 and its components are specifically referenced for descriptive/illustrative purposes, it will be appreciated that the method 300 could be applicable to any suitably configured FCEV. The method 300 begins at 304 where the control system 132 determines whether a set of preconditions are satisfied. This could include, for example, the FCEV 100 being powered up and running and there being no malfunctions or faults present (e.g., malfunctions of the fuel cell system 128) that would negatively impact or otherwise inhibit the operation of the predictive energy management techniques of the present application. The preconditions could also include the vehicle trip having been input/defined (e.g., by a driver via the driver interface 136) such that an endpoint/destination is known. At 308, the control system 132 collects the input (horizon) data as previously described herein.

At 312, the control system 132 generates the SOC profile for the trip including a plurality of trip segments and respective SOC allocations. At 316, the control system 132 applies or enforces constraints against the SOC profile to obtain a target (constrained) SOC profile (e.g., including a plurality of target SOC allocations for the plurality of trip segments). At 320, the control system 132 determines a dynamic fuel cell power request to achieve the target SOC profile at every stage of the vehicle trip. At 324, the control system 132 filters (e.g., applies an FLA filtering approach to) the dynamic fuel cell power request to determine a plurality of FLA-filtered power requests that collectively form a predictive fuel cell power request for the fuel cell system 132 for the trip. Finally, at 328, the control system 132 controls the fuel cell system 128 using the predictive fuel cell power request. The method 300 then ends or returns to 304 or 308 (e.g., for another cycle for a subsequent vehicle trip).

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A predictive energy management system for a fuel cell electric vehicle (FCEV), the predictive energy management system comprising:
a set of sensors configured to monitor a set of parameters relating to operation of an electrified powertrain of the FCEV during a trip, the trip including a plurality of trip segments and the electrified powertrain including a battery system having a state of charge (SOC), a fuel cell system, and an electric motor; and
a control system configured to:
determine, based on the set of parameters, an SOC profile defining a plurality of SOC allocations for the plurality of trip segments;
apply a set of constraints of the FCEV to the SOC profile to obtain a target SOC profile, wherein the set of constraints include at least one or more constraints for operation of the fuel cell system of the electrified powertrain;
determine a dynamic fuel cell power to achieve the target SOC profile at each of the plurality of trip segments;
filter the dynamic fuel cell power to obtain a predictive fuel cell power request for the fuel cell system; and
control the fuel cell system using the predictive fuel cell power request.

2. The energy management system of claim 1, wherein the filtering of the dynamic fuel cell power includes applying a forward-looking average (FLA) filter to the dynamic fuel cell power.

3. The energy management system of claim 2, wherein the predictive fuel cell power request includes a plurality of unique FLA-filtered fuel cell power segments for the plurality of trip segments, respectively.

4. The energy management system of claim 3, wherein the applying of the FLA filter to the dynamic fuel cell power includes calculating the unique FLA-filtered fuel cell power segments between a minimum SOC level for the battery system, a maximum SOC level for the battery system, a start of the trip, and an end of the trip.

5. The energy management system of claim 1, wherein the set of constraints includes at least a minimum power output of the fuel cell system and a maximum power output of the fuel cell system.

6. The energy management system of claim 5, wherein the set of constraints further includes at least a minimum SOC level of the battery system and a maximum SOC level of the battery system.

7. The energy management system of claim 1, wherein the set of operating parameters includes at least one of navigation information and environmental information.

8. The energy management system of claim 7, wherein the set of operating parameters includes both navigation information and environmental information, wherein the navigation information includes a set of road parameters including at least a road grade and posted speed limit, and wherein the environmental information includes at least an ambient temperature and an altitude or barometric pressure.

9. The energy management system of claim 1, wherein the controlling of the fuel cell system using the predictive fuel cell power request results in at least one trip segment where the battery system SOC increases.

10. A predictive energy management method for a fuel cell electric vehicle (FCEV), the predictive energy management method comprising:
monitoring, by a set of sensors of the FCEV, a set of parameters relating to operation of an electrified powertrain of the FCEV during a trip, the trip including a plurality of trip segments and the electrified powertrain including a battery system having a state of charge (SOC), a fuel cell system, and an electric motor;
determining, by a control system of the FCEV and based on the set of parameters, an SOC profile defining a plurality of SOC allocations for the plurality of trip segments;
applying, by the control system, a set of constraints of the FCEV to the SOC profile to obtain a target SOC profile, wherein the set of constraints include at least one or more constraints for operation of the fuel cell system of the electrified powertrain;
determining, by the control system, a dynamic fuel cell power to achieve the target SOC profile at each of the plurality of trip segments;
filtering, by the control system, the dynamic fuel cell power to obtain a predictive fuel cell power request for the fuel cell system; and
controlling, by the control system, the fuel cell system using the predictive fuel cell power request.

11. The energy management method of claim 10, wherein the filtering of the dynamic fuel cell power includes applying, by the control system, a forward-looking average (FLA) filter to the dynamic fuel cell power.

12. The energy management method of claim 11, wherein the predictive fuel cell power request includes a plurality of unique FLA-filtered fuel cell power segments for the plurality of trip segments, respectively.

13. The energy management method of claim 12, wherein the applying of the FLA filter to the dynamic fuel cell power includes calculating, by the control system, the unique FLA-filtered fuel cell power segments between a minimum SOC level for the battery system, a maximum SOC level for the battery system, a start of the trip, and an end of the trip.

14. The energy management method of claim 10, wherein the set of constraints includes at least a minimum power output of the fuel cell system and a maximum power output of the fuel cell system.

15. The energy management method of claim 14, wherein the set of constraints further includes at least a minimum SOC level of the battery system and a maximum SOC level of the battery system.

16. The energy management method of claim 10, wherein the set of operating parameters includes at least one of navigation information and environmental information.

17. The energy management method of claim 16, wherein the set of operating parameters includes both navigation information and environmental information, wherein the navigation information includes a set of road parameters including at least a road grade and posted speed limit, and wherein the environmental information includes at least an ambient temperature and an altitude or barometric pressure.

18. The energy management method of claim 10, wherein the controlling of the fuel cell system using the predictive fuel cell power request results in at least one trip segment where the battery system SOC increases.
